(19) United States
(12) Patent Application Publication
(10) Pub. No.: US 2007/0208464 A1
(43) Pub. Date: Sep. 6, 2007

(54) System and method of interactively compiling a database for an in-vehicle display device

(75) Inventor: Brian Moorhead, Willis, MI (US)

Correspondence Address: GIFFORD, KRASS, SPRINKLE, ANDERSON &;CITKOWSKI, PC, P.O. BOX 7021, TROY, MI, 48007-7021, US

(73) Assignee: FORD MOTOR COMPANY

(21) Appl. No.: 11/365,172

(22) Filed: Mar. 1, 2006

(51) Int. Cl. G05D 1/00

(52) U.S. Cl. 701/1

(57) ABSTRACT

A system and method of interactively compiling a composite database for use by an in-vehicle display device includes a user computer, a communications network, a central computer, and a geometric component part model library. The system further includes an executable display design software program that populates the composite database. The display device is controlled by an executable display device software program using information from the composite database. The method includes an executable module for selecting a component part model from the component part library, an executable module for selecting a material property describing the selected component part model, an executable module for defining an operator control for a display screen state and a corresponding action when the control is selected by the operator in the vehicle, an executable module for defining an information communication means that provides information to the defined user control, for display on the in-vehicle display device.

### BACKGROUND OF THE INVENTION

1. Field of the Invention

The present invention relates generally to an in-vehicle display device for a vehicle, and, more specifically, to a system and method of interactively compiling a database for use by an in-vehicle display device.

2. Description of the Related Art

An in-vehicle display device provides relevant information to an occupant of the vehicle and in particular to the operator of the vehicle. Information is typically offered in a visual format on a display screen. The information is usually displayed in a two-dimensional, plan view style graphic representation. The vehicle operator accesses the information via operator selectable screens. At present, the information provided by the display device is limited. One reason is the time and expense of developing the necessary software for each vehicle application. While the presently available display format conveys the necessary information, it may not provide the information in the best manner. In addition, the opportunity for user interaction or dynamic views of various vehicle components may be limited with the present display format. In addition, conventional display devices provide limited access to vehicle diagnostic information, or other such specialized information.

The current methods of designing an in-vehicle display device are time consuming and require significant user software knowledge. In addition, a unique software program is required for each product line. Further, the present methods do not take advantage of other information readily available to the vehicle designer.

At the same time, computer-assisted design techniques are frequently incorporated in the development of a new vehicle, or redesign of an existing vehicle. These computer-assisted design techniques include Computer-Aided Design (CAD) software tools and enhanced visualization software tools that allow for interactive display and manipulation of large-scale geometric models. One aspect of the design process is to construct a geometric model of the proposed design using a technique known as Computer-Aided Design (CAD). The combined use of Computer-Aided Design and visualization techniques is especially beneficial in the design and analysis of individual component parts with respect to the overall product. The CAD model of the vehicle or a component part is a more detailed representation than is presently displayed on the in-vehicle display device.

Thus, there is a need in the art for a system and method of automatically developing the operating software for an in-vehicle display device for a vehicle using a generic display architecture that can be customized for a particular vehicle application, in order to provide enhanced vehicle operator interaction and real-time information about the vehicle.

### SUMMARY OF THE INVENTION

Accordingly, the present invention is a system and method of interactively compiling a composite database for use by a database driven in-vehicle display device. The system includes a user computer system having a memory, a processor, a user input device and a display device; a communications network; and a central computer system operatively in communication with the user computer system via the communications network. The system also includes a component part library containing a computer generated geometric model of a component part, that is maintained in a database associated with the central computer system. The system still also includes an executable vehicle display design software program associated with the central computer system that populates a composite database. The vehicle display design software program includes an executable module for selecting a component part model from a component part library, an executable module for selecting a material property describing the selected component part model, an executable module for defining an operator control for a display screen state and a corresponding action when the control is selected by the operator in the vehicle, and an executable module for defining an information communication means that provides information to the defined user control to be displayed by the in-vehicle display device. The system further includes a display device on the vehicle having a display screen and a processor, and an executable display device software program is stored in a memory associated with the display device processor. The display device software program uses the display device definitions stored in the composite data storage device to operatively control the display device.

The methodology includes the steps of the defining a display screen state to be displayed on the in-vehicle display device and selecting a computer-aided design (CAD) model of a component part using a CAD data module, for the defined display screen state. The CAD data module optimizes a rendering of the selected component part. The method also includes the steps of defining a user control for the display screen state and a corresponding action when the control is selected using the user control definition module, and defining a material property for the selected component part for the display state using the material properties module. The method still also includes the steps of defining an information communications means to provide information to the defined user control to be displayed by the in-vehicle display device using the communications definition module. The method further includes the steps of using a vehicle display design computer software program to interact with the CAD data module, the communication definition module, material properties module, and user control module to populate a composite database. The methodology then uses the composite database and the display device software program associated with the vehicle display device to selectively operate the vehicle display device.

One advantage of the present invention is that a system and method of interactively compiling a database for an in-vehicle display device is provided that integrates available engineering data with engineering knowledge to create a database driven interactive display. Another advantage of the present invention is that a system and method is provided that automates the process of developing an in-vehicle display to improve the quality of information provided and enhance user interaction. Still another advantage of the present invention is that a system and method is provided that is simple to use and reduces the amount of time required to develop the in-vehicle display device software by the vehicle designer. A further advantage of the present invention is that a system and method of interactive design of an in-vehicle display is provided that improves real-time selectable views of the vehicle or a particular component. Still a further advantage of the present invention is that a system and method is provided that increases the amount of real-time diagnostic information available to the operator.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a diagrammatic view of a system of interactively compiling a database for an in-vehicle display device, according to the present invention.

FIG. 2 is another diagrammatic view illustrating the architecture for the system of FIG. 1, according to the present invention.

FIG. 3 is a view illustrating an in-vehicle display on the display device, according to the present invention.

FIG. 4 is a view illustrating another screen for the display device, according to the present invention.

FIG. 5 is a view illustrating still another screen for the display device, according to the present invention.

FIG. 6 is a flowchart illustrating a method of interactively compiling a database for an in-vehicle display device using the system of FIG. 1, according to the present invention.

FIGS. 7-10 are diagrammatic views of a series of computer screens illustrating the implementation of the method of FIG. 6 using the system of FIG. 1, according to the present invention.

### DESCRIPTION OF THE PREFERRED EMBODIMENT(S)

The interactive design of a database driven in-vehicle display device is preferably achieved with a generic, parametric driven analytical process. Advantageously, the interactive nature of the process allows for flexibility in design of the display device in a fraction of the time required using conventional design techniques. Various computer-based tools are integrated to achieve this enormous time and expense savings, including solid modeling, parametric design, and automated studies. In this example, the process is applied to a database and software program used in conjunction with an in-dashboard display device for an automotive vehicle, although other types of display devices or vehicles are foreseeable. The interactive design process advantageously utilizes preexisting data sources, such as that typically generated through the use of conventional computer-aided design (CAD), including computer-aided manufacturing (CAM) and computer-aided engineering (CAE) techniques.

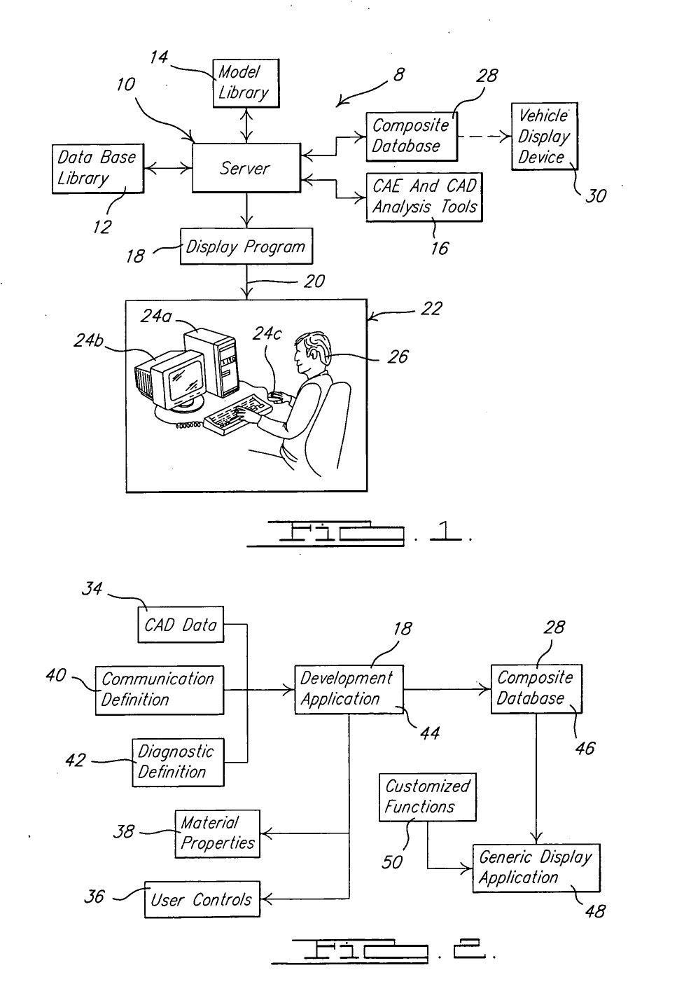

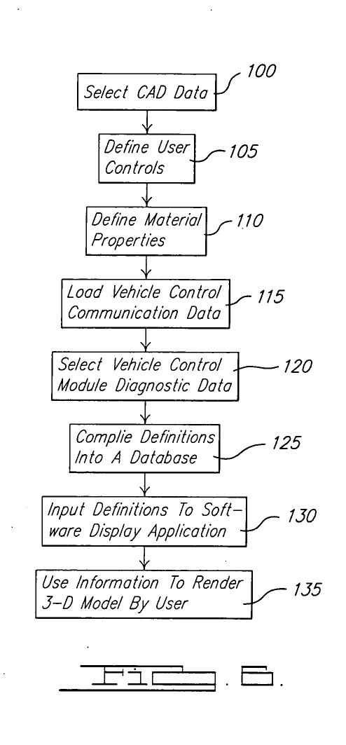

Referring to the drawings and in particular to FIGS. 1-5, a system 8 for interactively compiling a database for an in-vehicle display device is provided. In this example the vehicle is a hybridized fuel cell vehicle that operates on both electricity and hydrogen.

The system 8 includes a central computer system 10. The central computer system 10 includes a server having a processor, and a memory. The central computer system 10 may be in communication with other systems, such as a database or a user computer system 22, via a communications network 20. The communications network 20 may be of any type, such as wired, or wireless, without limitation. In this example, the communications network transfers information utilizing an internet, such as the Internet, or an intranet, or the like.

The user computer system 22 includes a processor, and a memory shown at 24a to process information relevant to the method. The user computer system 22 includes a display device 24b, such as a display terminal, to display information to the user 26 during the display design process. Preferably, the user computer system 22 is configured to provide for fast display capability for rendering and viewing of large, complex digital representations.

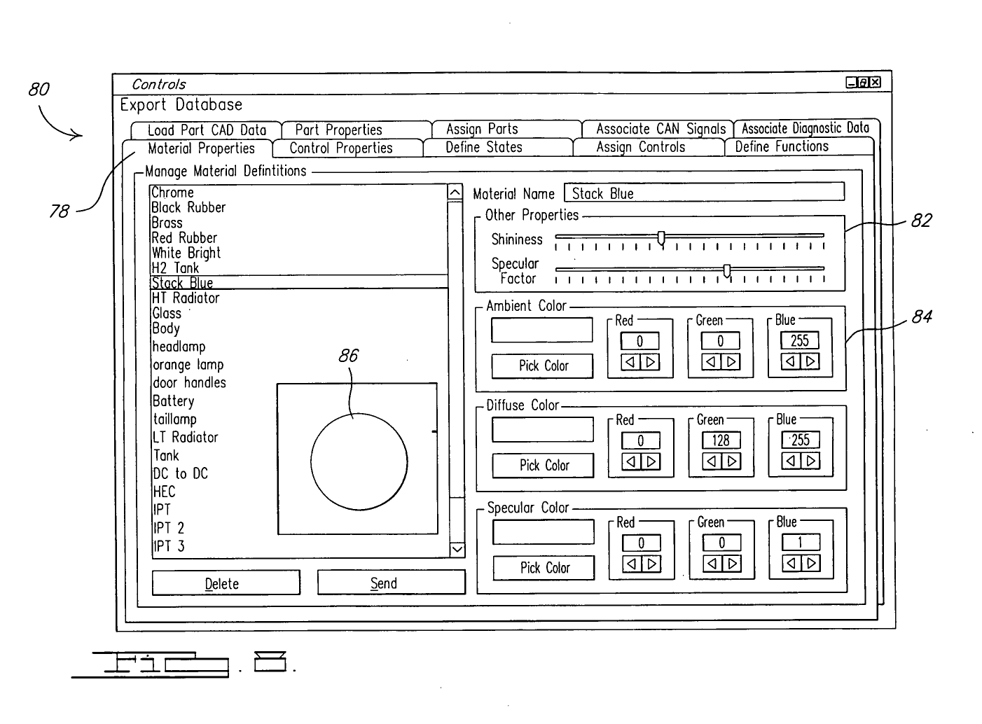

In this example, information is displayed on the user display device 24b in a series of screens, also referred to as a browser. Examples of such screens are illustrated in FIGS. 7-10. A user 26 inputs information into the user computer system 22 when prompted to do so. The information may represent different alternatives. Selection and control of the information within a screen can be achieved by the user 26, via a user interactive input device 24c, such as a keyboard or a mouse.

An example of an input method is a drawing technique used to draw a box around a local region of the model using the user input device 24c, such as the mouse. It should be appreciated that the drawing process includes a click, drag and release of the mouse, as is understood in the art. Another type of input method is a graphical user interface that allows menu selection, parameter modification and performs other types of viewing operations using the user input device 24c. Still another example of an input method is a pop-up dialog box containing available information or instructions.

The system includes an electronic storage device or information database 12 in communication with the user computer system. The database may be a single database, or a plurality of linked databases. The database 12 includes various information relevant to the method, such as product design specifications, or the like. The information may be categorically stored within a knowledge-based library associated with the database 12.

The information database 12 may also provide information to the user regarding a particular vehicle design. The database may further include information, such as standards, technical specifications, guidelines, practices, or the like. The information within the database may be organized into a subject matter based library. For example, a component part library may be available which details the specifications for a component part. Other information may reference predetermined product assumptions regarding the vehicle to be produced, such as model year, style, or production volume.

The information database 12 also includes a component part model database 14, preferably stored on an electronic storage device. In this example, the component part model database 14 contains models, or an electrical representation of vehicles and individual component parts for use in the vehicle. The models may be stored in a geometric mesh format or the like. The component part model database 14 catalogues the particular component parts, used on a vehicle or contains a geometric mesh model of the component part. The information within the database 14 may be organized into a subject matter based library.

For example, the model database 14 may include mesh modeling data for a vehicle and corresponding component parts, including minimum and maximum mesh size. It should be appreciated that the component part model database 14 may be integral with the information database 12.

The system 8 may also include various Computer-Aided Design (CAD) tools 16, which may be used by the method, to be described. CAD design tools 16 may encompass solid modeling, surface modeling visualization or parametric design techniques. Several modeling programs are commercially available and generally known to those skilled in the art. The parametric design technique is used in the electronic construction of geometry for designing the vehicle or a portion thereof.

The system 8 also includes various computer-aided engineering (CAE) analysis tools 16. One example of a CAE analysis tool is a preprocessor used to convert a CAD model into a geometric mesh model. Various commercially available software programs are utilized, such as EASICRASH, SOFY, MCRASH, Moedit, HYPERMESH or the like. The selection of the software tool is dependent on the capability of the particular software tool and the component part being analyzed.

An executable in-vehicle display design computer software program 18 utilizes the set of information or instructions from the user 26, information from the database 12, 14, design tools and analysis tools 16, to carry out the method to be described of interactively designing an in-vehicle display. The in-vehicle display design computer software program 18 is implemented by the user 26, and may be resident on the user computer system 22 or a central computer system 10.

The in-vehicle display software program 18 is utilized to integrate vehicle computer-aided design data with other user defined data into a composite database used by the vehicle display device. The data includes a rendering of the component part, the number of component parts in the vehicle, the orientation of the vehicle or component parts, or the like. This virtual design process is a time saver over current manual in-vehicle display design practices. It also ensures the quality and consistency of the resulting composite database across various models of vehicle, and across model lines.

Advantageously, this is a time and cost savings as compared to previous design methods. In addition, the computer-implemented method of interactively developing the operating database for an in-vehicle display device combines all of the foregoing to provide an efficient, flexible, rapid tool. Furthermore, the composite database 28 of selections is available for further analysis and study.

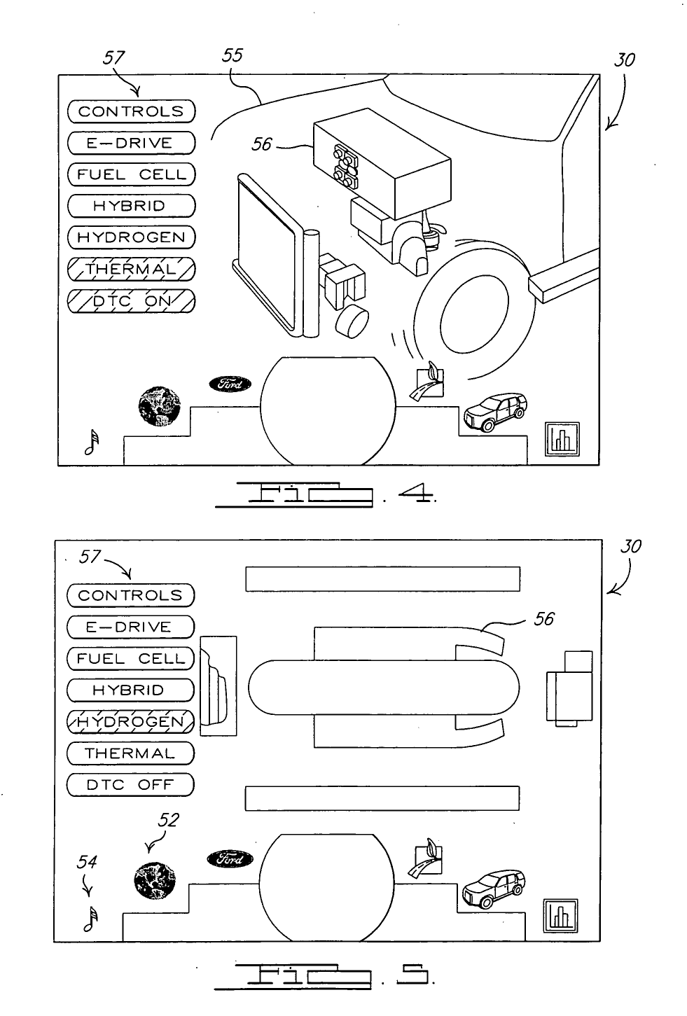

The system also includes a vehicle display device 30. In this example, the display device 30 is integral with the dashboard. The display device 30 contains a screen, an input means and a processor. A display device software program is resident within the memory of the processor, and utilizes the information from the user and stored in the composite database as an input. Information is displayed on the display screen in a predetermined format as shown in FIGS. 3-5. The screen may be touch sensitive in order to transmit the operator's input. The display may include a rendering of the vehicle, as shown at 55, or a component part, as shown at 56. The operator controls for selecting information to be displayed are shown at 57.

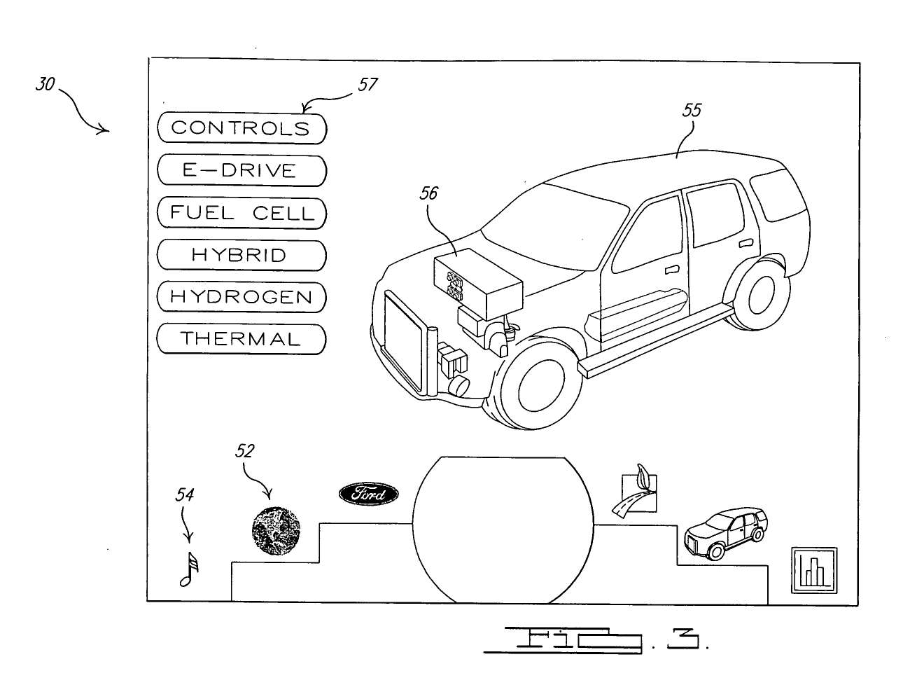

The in-vehicle display software program 18 may include executable modules for implementing the methodology. An example of an architecture 32 of typical modules is illustrated in FIG. 2. It should be appreciated that these modules are merely illustrative, and other modules may also be utilized. In. addition, the order of execution of these modules is user selectable.

In block 34, the module is a CAD data module that preprocesses existing CAD data to build a list of vehicle parts to be displayed on the display device. This module is typically the first application module launched by the user 26. Various user selected options are specified using this module, such as component part selections. The CAD model is organized as nodes. Several types of nodes may be utilized and they may be arranged in a hierarchical manner. VRML geometry is represented as nodes of geometric data acted upon by a set of nodes of transform data. The set of transforms are all the predecessor transform nodes of the geometric node. The VRML data may have a complex hierarchy of transforms. The VRML preprocessor transforms all the geometry into a single coordinate system. It also filters out unnecessary geometry, such as lines, curves or points, or the like, in order to optimize the rendering of the component part.

In block 36, a user control definition module is illustrated. The user control definition module 36 defines the display screen states and determines which user controls are displayed on the screen for each state and the appropriate action associated with each control selected by the operator, as shown in FIGS. 3-5. In block 38, a materials properties module is illustrated. This module defines the material properties for the component parts on the in-vehicle display. In particular, it links the selected CAD parts with a material database.

In block 40, a communication definition module is illustrated. This module is in communication with the vehicle controller, and facilitates the selective transport of information between modules. For example, the user selects the fuel cell icon on the display device 30 and the present power level is displayed.

In block 42, a vehicle control diagnostic data module is illustrated. This module links a diagnostic definition database to the selected CAD part data so the display device 30 may query the various control modules for their diagnostic information and display the diagnostic information. The types of diagnostic information include trouble codes and parameter data for a part in need of service. Advantageously, the user 26 may be able to include trouble-shooting information and recommended actions for the operator to implement, such as those typically found in the owner's manual for the vehicle.

In block 44, the vehicle display design computer software program 18 is illustrated. This program may be resident in the user computer system 22 or the centralized computer system 10 and accessed by the user computer system 22. As shown, the display design software program 18 interacts with the other modules in order to populate the composite database used by the vehicle display device software program 48.

In block 46, the composite database 28 is illustrated. This database stores files containing the inputs and selections from the previous modules. Preferably, the information is maintained by the composite database for use by the vehicle display device software program 48.

In block 48, the generic vehicle display device software application 48 is illustrated. This software application takes all the selected information from the composite database 28, and uses this information to operatively control the display device 30, by allowing the operator to navigate the various display screens in order to perform the desired function. The display device software program 48 advantageously utilizes the information loaded from the composite database 28 to render the three-dimensional models of the user controls and vehicle component parts on the display device 30.

In block 50, a customized function module is illustrated. In particular, this module integrates vehicle model specific functions and features that supplement the display device software application 48. An example of a customized function is a link to the vehicle navigation system in order to provide the operator with navigation information, as shown in FIG. 3 at 52. Another example of a customized function is a link to the vehicle sound system, as shown at 54. The addition of customized features increases the flexibility of the system.

It should be appreciated that the user may selectively move between modules as part of the design process.

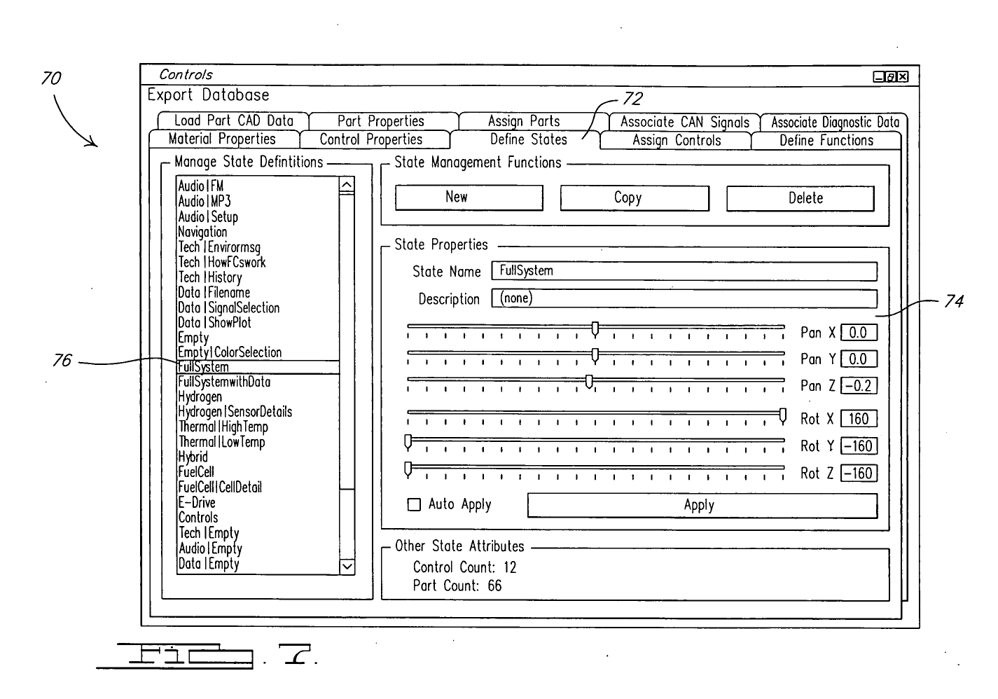

Referring to FIG. 6, a flowchart of a method of interactively compiling a database for an in-vehicle display device is illustrated using the modules described with respect to FIGS. 1 and 2. The display design software program 18 may be resident on the central computer system 10 and accessible by the user computer system 22, or resident on the user computer system 22. The methodology provides a dynamic method for quickly designing a vehicle display on a vehicle display device having predetermined features. These features may include a display of the vehicle 55, an energy flow diagram, or a display of the current vehicle operating state, or a diagnostic condition or the like. These features may also be interactive, allowing the vehicle operator or another vehicle user to select information to be displayed using the controls 57. The end result is a customized database for operating a vehicle display device 30 that incorporates these predetermined features, in order to define the behavior of the display device.

The display design software program 18 implementing the method advantageously integrates various software tools and expert knowledge to automatically populate files that are maintained in a composite database 28 associated with the display design software application 18. The methodology provides for efficient modifications to the database 28. The methodology takes advantage of the automated process. to selectively populate the composite database 28 using the display design software application 18, irrespective of the expertise of the user 26.

The methodology begins in block 100, with the user 26 selecting an image to be displayed by the display device 24b. The image can be of an entire vehicle, a portion of the vehicle, or of selected component parts. In this example, the vehicle images are in a computer-aided design (CAD) format. The CAD format is advantageous because it provides a more realistic three-dimensional image.

In order to select the desired image, the user may be provided with a screen containing various options, including a tab for loading component part data. By selecting the Load Part CAD Data tab, the user is provided another screen containing user controlled options for selecting the data file corresponding to the desired image. As previously described, the data files may be stored in a library, and the user accesses the library to select the CAD data file.

For example, the user 26 is provided a window or screen, and has the option of using the user input device 24c to select a component part from a list describing component parts stored in the component part model database 14. The mesh model of the selected component part may also be shown on the display device.

The component part may be stored in a variety of formats. For example, the component part may be represented as a geometric model in a CAD format. Various CAD compatible formats may be supported, such as VRML, stl, or .jt or the like. The user interface may provide for the selection of various operations, such as defining a drive to load the files from, defining the folder to load files from, selecting the files to be loaded and loading part names from the selected files, or the like.

The selected geometric data for the component part is imported into the executable display design computer software program 18. The user may select to have the data optimized in order to enhance rendering performance. The CAD data file may be converted into a mesh file using commercially available software, such as IDEAS or ANSA or HYPERMESH or the like. For example, the CAD data provides a surface of mesh elements, and these surface normal vectors may be calculated for these elements in order to render the component part in three dimensions with predetermined shading on the user display. In the example of a NASTRAN file, this process may include the following steps, all vertex data is loaded into the program in a GRID format, all triangle definitions are loaded into the program in a CITRA3 format, the triangle lists are restructured into Open GL style triangle strips. The normal vector for each vertex may be calculated in order to achieve rendered lighting effects. Other operations include storing part definitions to composite database, storing vertex data in a binary file, and storing triangle strip data in a binary file.

The methodology may also optimize the order in which the elements are displayed on the screen, in order to optimize rendering performance to maintain a consistent display frame rate, such as thirty frames per second. After the user selects a particular component part, the component part data file may be displayed on the display screen. The methodology advances to block 105.

In block 105 the user 26 defines the display screen states and determines user controls 57 that are utilized by the in-vehicle user to change the display on the display screen 30, and the action corresponding to the specified user control 57. Examples of types of controls are buttons, slide bars, progress bars, control knobs, text display or the like.

The user may select a tab, such as Define States in order to manage display screen states. The user is provided with a screen as shown in FIG. 7 at 70 when the Define States tab 72 is selected. For example, the user interface shall provide for a create, copy or delete program state. The user 26 may be able to set the X, Y, and Z pan offsets for the states, or the X, Y, and Z rotation offsets for the state, as shown at 97. The user 26 may further select to define the target state for when a given part is selected by the user 26, as shown at 76.

In addition, the user may select a tab, such as the Control Properties tab to define the in-vehicle user controls 57. The user 26 is provided with a screen listing the various generic controls that are available. In addition to the type of control, the user 26 may select other features such as the size of the control, the position of the control, display text, background images, material properties, and sound effects. The user 26 may define the application state to which the specific control applies, as well as a new target state or function that is executed when the control 57 is actuated. It should be appreciated that the selected user controls and user control features may be saved to another database, such as an external database, for use by other applications.

As previously described, the user 26 is preferably provided a window on the display device 24b containing relevant parameters. Using the user input device 24c, the user 26 may highlight and select an option. Example of user interface options includes setting the control's name property, setting the control's sound effect, setting the control's target state, setting the control's target function, or setting the control's size and location on the screen.

The methodology advances to block 110, and the user defines properties for all objects in the display. For example, the user selects an Assign Part Properties tab, and is provided with a window with options for associating properties to a component part. These property options are presented in a window, and the user 26 utilizes the user input device 24c to make a selection. The user interface may provide for operations such as defining a name property for the selected part, defining a description for the selected part, or setting a material property for the selected part.

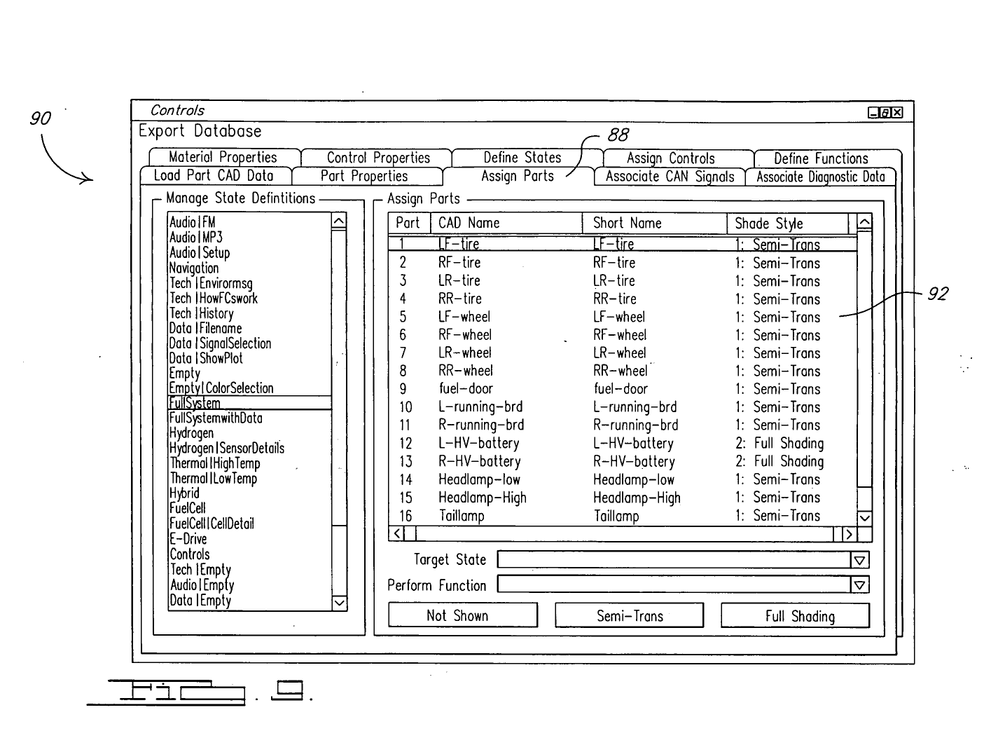

By selecting the material properties tab 78, a window is displayed as shown in FIG. 8 at 80. The user may link the component part to the material property for the defined part.

The user 26 may be linked with a material database in order to further define the material property for the selected part. The material database is a database containing a material name, and features, such as surface shininess, percent transparency, as well as ambient, diffuse and reflective colors. For example, the user 26 may select an operation to set a material common name or set a material shininess property, as shown at 82. The user 26 may also select a property to set a specular color exponent property, or set an ambient color red, green or blue value, or set a diffuse color red, green or blue value, or set a specular color red, green or blue value, or the like, as shown at 84. The user 26 may also select an operation to save a material property definition to a composite database or to delete a material definition from a composite database, or other similar operations.

The selected material properties may be saved in an external database, and are available for other uses. The user 26 may be provided with an image of the component part with the selected material properties, as shown at 86.

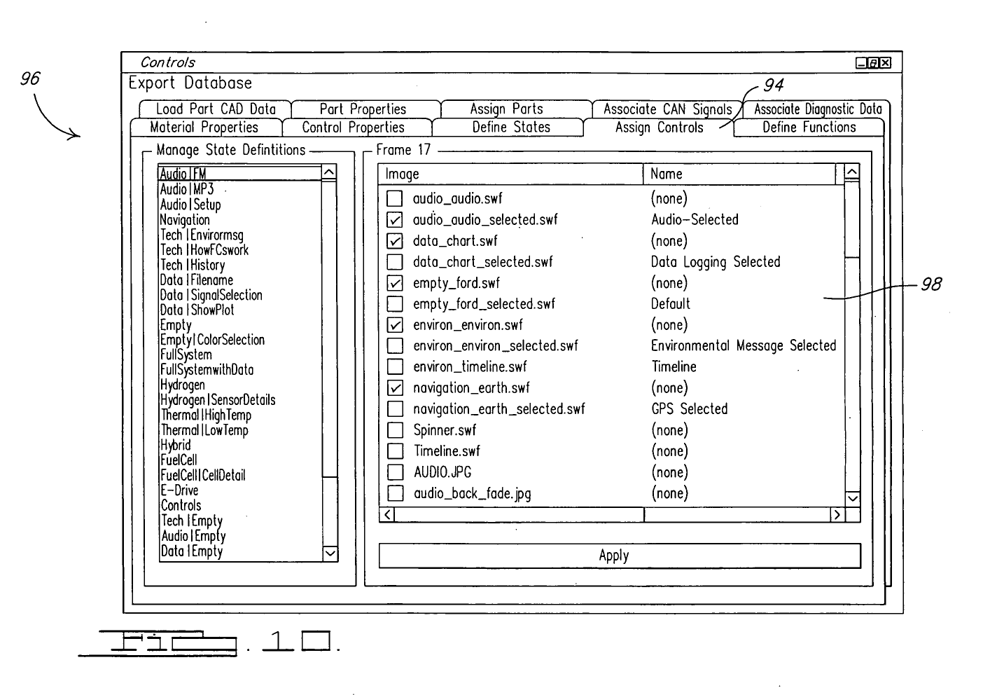

The user 26 may select an Assign Parts tab, as shown at 88 in FIG. 9 in order to have a screen 90 displayed for assigning particular CAD component parts to a corresponding display program state. For example, the user interface may provide for the selection of an operation that sets the display style for the part. Examples of display style include Not Shown, Semi-transparent or Full as shown at 92. The user 26 may select an operation the sets the target display program state for when a given part is selected by the user 26. The user 26 may also select an operation that sets the function index for when a given part is selected by the user 26. The methodology advances to block 115.

In block 115, the user 26 selects communication data corresponding to a predetermined control 57 to be displayed when that control is selected by the in-vehicle user. Examples of communication definitions include operating state, temperature, vehicle, speed, voltage, current and power. These communication definitions provide the in-vehicle user with information that is selectively displayed on the vehicle display device 30. The information may be received from various input sources.

For example, the user 26 may select an Assign Controls tab 94, as shown in FIG. 10 at 96, and is presented with a screen for assigning user controls to display program states. For example, the user interface shall provide for an operation to create, save, copy or delete display program states, as shown at 98. The user interface may also provide for an operation to create, save, copy or delete user controls 57. Further, the user 26 may be able to define the top, left, height or width properties for the user control 57. The user 26 may be able to define the image file for the control, such as a JPEG, Bitmap, Shockwave Flash or movie file. The user 26 may be able to select a sound effect file for when the control 57 has been selected, such as a WAV or MP3 file or the like. The user 26 may select a target state for when the control 57 is selected by the in-vehicle user, or define a function index for when the control is selected by the in-vehicle user.

The user 26 may also select an Associate CAN Signal tab, in order to assign a CAN signal to a physical attribute of a CAD part. The user 26 may select from an operation to select a component part for attribute association. The user 26 may select a data source, such as Strobe (1 second averaged data) or Raw (unfiltered data). The user may select the signal type, such as temperature, voltage, current speed or the like. The user 26 may select a CAN signal used to populate the attribute data. The user may select signal units. The user may further build and remove attribute associations.

In block 120, the user 26 may select an Associate Diagnostic Data tab in order to link the selected component parts corresponding with vehicle diagnostics for viewing on the vehicle display device. For example, the user 26 may be provided with a screen allowing the user 26 to select diagnostic codes and associating the selected diagnostic codes with the selected component parts. When the diagnostics control is selected by the in-vehicle user, the user may be linked to a diagnostic definition database that is linked to the CAD part data, such that the vehicle display device can query the various control modules for their diagnostic information and displays the diagnostic information in real time. Various types of diagnostic information may be presented, such a message, a trouble code or parameter data for a component part in need of service. In addition, the user 26 may select to add trouble-shooting information and recommended actions pertaining to the selected component part, for access by the in-vehicle user.

The user interface may also provide for an operation that allows the selected CAD parts to be added or removed from the list of Diagnostic Trouble Codes. The methodology advances to block 125.

The user 26 may select a Define Functions tab in order to define custom program functions to be developed by the programmer. For example, the user 26 may select an operation to create, copy or delete a target function. The user 26 may select an operation to set a function name, a program enumerator or program comments. The user 26 may also generate custom function software header code.

In block 125, the user 26 compiles the previously selected definitions into a data file maintained in a composite database 28. In particular, the data file contains the selected CAD part properties, user controls, material definitions, communications definitions and diagnostic definitions for use by the in-vehicle display software application. The definitions may be summarized and displayed as a window on the display screen.

The methodology advances to block 130, and the user imports the data file from the composite database 28 containing the definitions, including CAD part properties, user controls, material definition, communication definitions, and diagnostic definitions into the vehicle display device software application program 48. The display device software program 48 uses the information from the composite database to operate the vehicle display device 30.

In block 135, the in-vehicle operator selectively navigates the various display screens or states using the controls in order to receive predetermined information, as shown in FIGS. 3-5.

It should be appreciated that the above-described methodology is executable in an iterative manner. The user 26 may advantageously elect to selectively change a design parameter as part of a comprehensive packaging study for a component part.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A system for of interactively compiling a composite database for use by a database driven in-vehicle display device comprising:
a user computer system, wherein said user computer system includes a memory, a processor, a user input device and a display device;
a communications network;
a central computer system operatively in communication with said user computer system via said communications network, wherein said central computer system includes a processor, and a memory;
a component part library containing a computer generated geometric model of a component part, wherein the component part library is maintained in a database in communication with the central computer system via said communications network;
an executable vehicle display design software program associated with said central computer system that populates a composite database, wherein the vehicle display design software program includes an executable module for selecting a component part model from a component part library, an executable module for selecting a material property describing the selected component part model, an executable module for defining an operator control for the display state and a corresponding action when the control is selected by the operator in the vehicle, and an executable module for defining an information communication means that provides information to the defined user control to be displayed by the in-vehicle display device; and
a display device on the vehicle, wherein the display device includes a display screen, and a processor and an executable display device software program is stored in a memory associated with the display device processor, and the display device software program uses the display device definitions stored in the composite data storage device to operatively control the display device.

2. A system as set forth in claim 1 wherein said data. Storage means includes a component parts library containing a geometric mesh model of a component part in a computer-aided design (CAD) format.

3. A system as set forth in claim 1 wherein said vehicle display design software program further includes a diagnostic definition module for selectively displaying diagnostic information related to the selected component part on the display device.

4. A system as set forth in claim 1 wherein said vehicle display design software program further includes a customized function module for selectively displaying navigation information from a navigation device on the display device.

5. A system as set forth in claim 1 wherein said vehicle display design software program further includes a customized function module for selectively displaying audio information from an audio device on the display device.

6. A method of interactively compiling a composite database for use by a database driven in-vehicle display, said method comprising the steps of:
defining a display screen state to be displayed on the in-vehicle display device;
selecting a computer-aided design (CAD) model of a component part using a CAD data module for the display screen state, wherein the CAD data module optimizes a rendering of the selected component part;
defining a user control for the display screen state and a corresponding action when the control is selected, using a user control definition module;
defining a material property for the selected component part for the display screen state using a material properties module;
defining an information communications means to provide information to the defined user control to be displayed by the in-vehicle display device, using a communications definition module;
using a vehicle display design computer software program to interact with the CAD data module, the communication definition module, diagnostic definition module, material properties module, user control module to populate a composite database; and
using the composite database by the display device software program associated with the vehicle display device to selectively operate the vehicle display device.

7. A method as set forth in claim 6 further including the step of linking a diagnostic definition database to the selected component part to display diagnostic information by the in-vehicle display device, using a vehicle control diagnostic data module.

8. A method as set forth in claim 6 further including the step of linking information from another vehicle information means to the in vehicle display device, using a customized function module.

9. A method as set forth in claim 6 wherein said step of selecting a component part further includes the step of selecting a geometric model of the component part from a library of geometric component part models maintained in a data storage device.

10. A method as set forth in claim 9 wherein the geometric model of the selected component part is in a computer-aided design (CAD) format.

11. A method as set forth in claim 6 wherein said step of defining the display screen state further includes the step of assigning the selected component parts to the defined display screen state.

12. A method as set forth in claim 6 wherein said step of defining the material property further includes the step of saving the selected material properties in a database associated with the central computer system.

13. A method as set forth in claim 6 further including the step of linking the selected component part with navigation information for a navigational device associated with the vehicle, wherein the navigation information is displayed by the in-vehicle display device.

14. A method of interactively compiling a composite database for use by a database driven in-vehicle display device, said method comprising the steps of:
selecting a geometric model of a component part using a user computer system that is in communication with a central computer system, wherein the geometric model of the component part is selected from a component part model database associated with the central computer system via a communications network;
defining a display screen state to be displayed on the in-vehicle display device;
defining a user control associated with the defined display screen state and a corresponding action associated with the defined user control, for selectively viewing information on the in-vehicle display device using a user control definition module;
defining a material property associated with the selected component part using a material properties module;
defining a vehicle data input means that is associated with the defined user control, wherein the data from the vehicle data input means is displayed by the in-vehicle display device;
compiling the selected component part definitions, user control definitions, material property definitions, and vehicle control communication definitions into a composite database;
using the definitions from the composite database to execute a display device software program associated with the in-vehicle display device.

15. A method as set forth in claim 14 wherein said step of selecting a component part further includes the step of selecting a geometric model of the component part from a library of geometric component part models maintained in a data storage device.

16. A method as set forth in claim 14 wherein said step of defining the display screen state further includes the step of assigning the selected component part to the display screen state.

17. A method as set forth in claim 14 further including the step of linking the selected component part with corresponding diagnostic information, wherein the corresponding diagnostic information is displayed by the in-vehicle display device.

18. A method as set forth in claim 14 wherein said step of defining the material property further includes the step of saving the selected material properties in a database associated with the central computer system.

19. A method as set forth in claim 14 wherein the geometric model of the selected component part is in a computer-aided design (CAD) format.

20. A method as set forth in claim 14 further including the step of linking the selected component part with navigation information for a navigational device associated with the vehicle, wherein the navigation information is displayed by the in-vehicle display device.
